(19) United States
(12) Patent Application Publication
(10) Pub. No.: US 2008/0186298 A1
(43) Pub. Date: Aug. 7, 2008

(54) DISPLAY APPARATUS

(75) Inventors: Hisashi MAMIYA, Kanagawa (JP); Tsuyoshi KAMADA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/020,280

(22) Filed: Jan. 25, 2008

(30) Foreign Application Priority Data
Feb. 7, 2007 (JP) 2007-027752

(51) Int. Cl. G09G 5/00

(52) U.S. Cl. 345/211

(57) ABSTRACT

A display apparatus in which switch elements and pixels are placed at intersections between multiple gate lines and multiple data lines on a display panel that displays video and which displays video by controlling the lighting of the pixels by turning on/off the switch elements based on the voltages applied to the gate lines and the data lines is disclosed. The apparatus includes:
a gate on voltage generating section that generates multiple VGG voltages (that is, gate on power supply voltages) for controlling the switch elements and controls the gradients at least at the trailing edges of the VGG voltages;
gate drivers that generate control signals that control the lighting of the pixels by turning on/off the switch elements based on the VGG voltages and supply the control signals to the gate lines; and
wires that supply the VGG voltages separately to one or multiple sets of the gate drivers.

### CROSS REFERENCES TO RELATED APPLICATIONS

The present invention contains subject matter related to Japanese Patent Applications JP 2007-027752 filed in the Japanese Patent Office on Feb. 7, 2007, the entire contents of which being incorporated herein by reference.

### BACKGROUND OF THE INVENTION

1. Field of the Invention

The present invention relates to a display apparatus having gate lines and data lines in a matrix form.

2. Description of the Related Art

In recent years, a large-screen display apparatus is now in increasing demand for enjoying video with a sense of realism with the spread of video machines such as a DVD (Digital Versatile Disc) and a “Blu-ray (trademark)” and the start of Hi-Vision broadcasting such as terrestrial digital television broadcasting. In the past, a display apparatus generally includes a CRT (Cathode Ray Tube) as a large-screen display apparatus. However, from the viewpoint of the decreases in size and/or power consumption, for example, an LCD (Liquid Crystal Display) with low power consumption has been rapidly spread since the size can be reduced more than that of a CRT.

An LCD generates a liquid crystal panel drive signal based on an input video signal and turns on/off a transistor with the liquid crystal panel drive signal to change the voltage to be applied to the liquid crystal. Thus, the transmission and interruption states to the light to pixels can be controlled. Then, the image colored by the concentration of the pixels can be displayed on a display section.

Now, with reference to FIG. 7, an example configuration of an LCD in the past will be described. An LCD 100 includes, as shown in FIG. 7, a display panel 110, a gate line driving circuit 120, a data line driving circuit 130 and a gate on voltage generating section 140. In this example, parts highly related to the display of the LCD 100 will be only described, and the description on the other parts will be omitted.

On the display panel 110, multiple gate lines 150, 150, . . . and 150 (which will be called gate lines 150 properly if the distinction among the gate lines is not necessary) and multiple data lines 160, 160, . . . and 160 (which will be called data lines 160 properly if the distinction among the data lines is not necessary) are orthogonal to each other in a matrix form. Pixels 112 are placed on the intersections between the gate lines 150 and the data lines 160 through switch elements 111 such as TFTs (Thin Film Transistors).

The gate on voltage generating section 140 generates a VGG voltage (gate on power supply voltage) for controlling the gate line driving circuit 120 in synchronization with a gate drive timing signal supplied from a timing controller, not shown. The gate line driving circuit 120 generates a control voltage for turning on/off the switch element 111 and supplies it to the gate line 150 based on the gate ON/OFF power supply voltage and the gate drive timing signal from the timing controller. The data line driving circuit 130 supplies a video signal to the data line 160. The display panel 110 controls the lighting of the pixel 112 and displays a video signal supplied from the data line driving circuit 130 to the data line 160 by switching on/off the switch element 111 with a control signal supplied from the gate line driving circuit 120.

The gate line driving circuit 120 includes multiple gate drivers 121, 121, . . . 121 (which will be called gate drivers 121 if the distinction among the gate drivers is not necessary) as shown in FIG. 8, and the gate drivers 121 are implemented on flexible wiring substrates 122, 122, 122, . . . and 122 (which will be called flexible wiring substrates 122).

The gate drivers 121 can drive the multiple, approximately 200, gate lines 150 and supply a control signal for lighting up the desired pixels 112 to the gate line 150 by turning on/off the switch elements 111 based on the VGG voltage supplied from the gate on voltage generating section 140. The gate driver 121 supplies a VGG voltage to the next gate driver 121 as it is.

A wire 123a for supplying a VGG voltage to the first gate driver 121 is connected to the gate on voltage generating section 140. The gate on voltage generating section 140 supplies a VGG voltage to the first gate driver 121 through the wire 123a. The first gate driver 121 supplies the received VGG voltage to the next gate driver 121 through the wire 123b on the display panel 110 and the flexible wiring substrate 122.

In the same manner, the gate driver 121 supplies the received VGG voltage to the next gate driver 121 through the wire 123b on the display panel 110 and the flexible wire substrate 122. In this way, the VGG voltage generated by the gate on voltage generating section 140 is supplied from the gate driver 121 to the subsequent gate driver 121 through the wire.

The technology relating to the driving circuit for an LCD in the past as described above is disclosed in JP-A-2000-221474 (Patent Document 1).

### SUMMARY OF THE INVENTION

As described above, in an LCD in the past, a gate on voltage generating section generates a single VGG voltage and supplies the generated VGG voltage to gate drivers through the previous gate drivers. In this case, an LCD in a larger size has longer wiring distances from the gate on voltage generating section to the gate drivers, which increases the wiring impedance due to the wiring resistance and/or wiring capacitance. Therefore, the VGG voltages input to the gate drivers have variations in intensity among the gate drivers since the waveforms become dull due to the wiring impedance.

In particular, the VGG voltages to be input to the gate on voltage generating section 140 largely differ between the first gate driver and the last gate driver. In a case where a wire in the panel is used as the wire for connecting the gate drivers, the impedance caused by the wire in the panel is higher than that of the wire provided on the wiring substrate, for example. Therefore, the influence by the increases in wiring distances becomes significant.

In order to solve the problem, the impedance of the wire for connecting the gate drivers may be reduced. For example, the wiring impedance can be reduced by adjusting the film thickness and/or wiring width of the wiring pattern.

However, a panel has a limited space available for wiring and has a yield problem. There is a limit to the adjustment of the wiring pattern on the panel for reducing the wiring impedance.

Accordingly, it is desirable to provide a display apparatus that can reduce variations in intensity by inputting substantially equal VGG voltages to gate drivers.

According to an embodiment of the present invention, there is provided a display apparatus in which switch elements and pixels are placed at intersections between multiple gate lines and multiple data lines on a display panel that displays video and which displays video by controlling the lighting of the pixels by turning on/off the switch elements based on the voltages applied to the gate lines and the data lines, the apparatus including a gate on voltage generating section that generates multiple VGG voltages (that is, gate on power supply voltages) for controlling the switch elements and controls the gradients at least at the trailing edges of the VGG voltages, gate drivers that generate control signals that control the lighting of the pixels by turning on/off the switch elements based on the VGG voltages and supply the control signals to the gate lines, and wires that supply the VGG voltages separately to one or multiple sets of the gate drivers, wherein the gate on voltage generating section supplies multiple VGG voltages having different gradients at least at the trailing edges to the one or multiple sets of gate drivers through the wires.

The VGG voltages at the input ends of the gate drivers can be substantially equal due to the effects of wiring resistance and/or wiring capacitance, for example, since the embodiment of the invention includes a gate on voltage generating section that generates multiple VGG voltages for controlling the switch elements and controls the gradients at least at the trailing edges of the VGG voltages, gate drivers that generate control signals that control the lighting of the pixels by turning on/off the switch elements based on the VGG voltages and supply the control signals to the gate lines, and wires that supply the VGG voltages separately to one or multiple sets of the gate drivers, wherein the gate on voltage generating section supplies multiple VGG voltages having different gradients at least at the trailing edges to the one or multiple sets of gate drivers through the wires, as described above.

According to the embodiment of the invention, the variations in intensity occurring among the gate drivers can be reduced since the VGG voltages at the input ends of the gate drivers can be substantially equal due to the effects of the wiring resistance and/or wiring capacitance, for example, by generating multiple VGG voltages having different gradients at the trailing edges and supplying the VGG voltages separately to one or multiple sets of the gate drivers by the gate on voltage generating section.

### BRIEF DESCRIPTION OF THE DRAWINGS

FIG. 1 is a schematic diagram showing an example configuration of a display apparatus according to an embodiment of the invention;

FIG. 2 is a schematic diagram showing an example configuration of a gate on voltage generating section;

FIG. 3 is a schematic diagram showing an example configuration of a gate driving circuit;

FIG. 4 is a section diagram for explaining a method for connecting a flexible wiring substrate and a display panel by using ACFS;

FIG. 5 is a schematic diagram for explaining wiring from a gate on voltage generating section to gate drivers;

FIGS. 6A to 6C are schematic diagrams for explaining waveforms of VGG voltages generated by the gate on voltage generating section;

FIG. 7 is a schematic diagram showing an example configuration of a display apparatus in the past; and

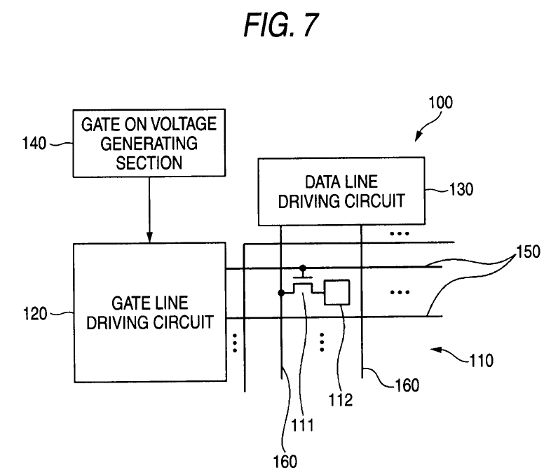

FIG. 8 is a schematic diagram for explaining wiring from a gate on voltage generating section to gate drivers in a display apparatus in the past.

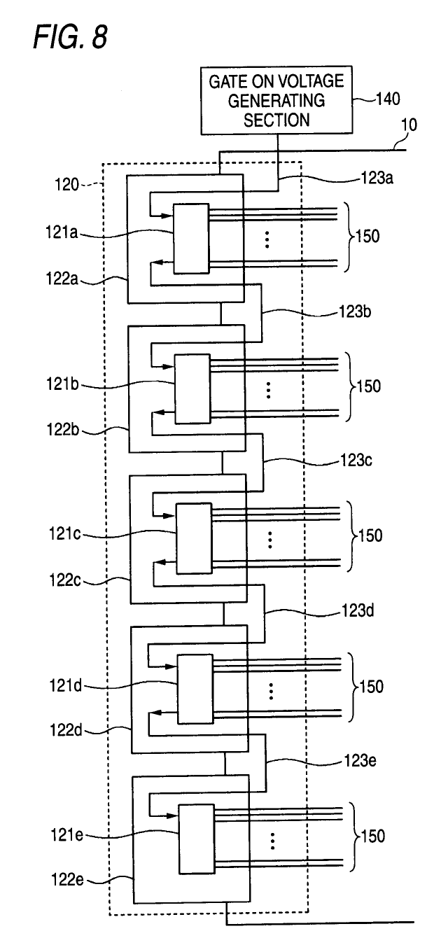

### DESCRIPTION OF THE PREFERRED EMBODIMENTS

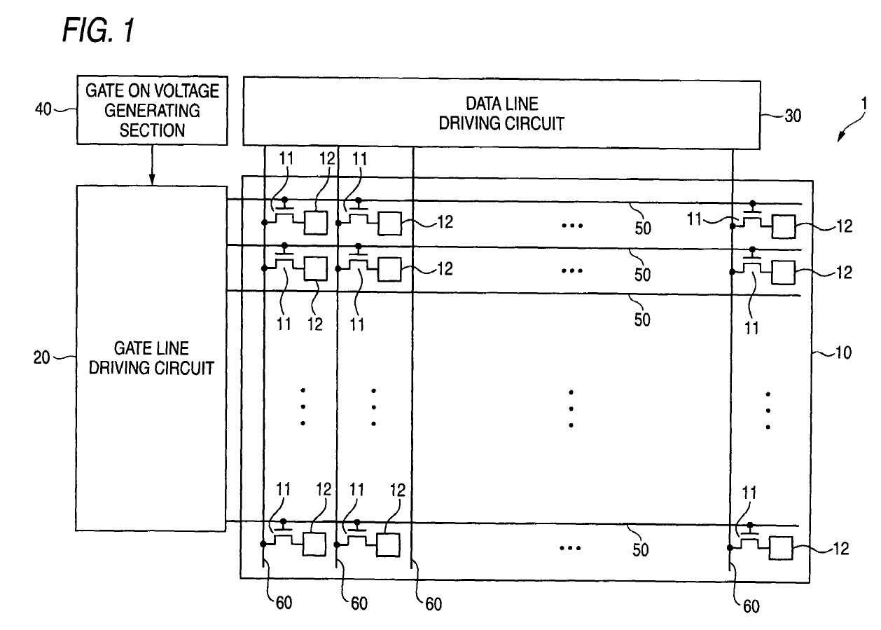

With reference to drawings, embodiments of the invention will be described below. As shown in FIG. 1, a display apparatus 1 according to an embodiment of the invention includes a display panel 10, a gate line driving circuit 20, a data line driving circuit 30 and a gate on voltage generating section 40. It should be noted that parts relating to display will be only described in the configuration of the display apparatus 1, and the description on the other parts will be omitted.

On the display panel 10, multiple gate lines 50, 50, . . . and 50 (which will be called gate lines 50 properly if the distinction among the gate lines is not necessary) and multiple data lines 60, 60, . . . and 60 (which will be called data lines 60 properly if the distinction among the data lines is not necessary) are orthogonal to each other in a matrix form. The display panel 10 may be a glass substrate, for example. Pixels 12 are placed on the intersections between the gate lines 50 and the data lines 60 through switch elements 11. The lighting of the pixels 12 is controlled by turning on/off the switch elements 11. Each of the switch elements 11 may be a thin film transistor (TFT).

The gate lines 50 are connected to the gate line driving circuit 20. The gate line driving circuit 20 scans vertically based on the VGG voltages supplied from the gate on voltage generating section 40, which will be described later, and supplies control signals for turning on/off the switch elements 11 to the gate lines 50. Details of the gate line driving circuit 20 will be described later. The data lines 60 are connected to the data line driving circuit 30. The data line driving circuit 30 supplies a video signal to the data lines 60 and scans horizontally.

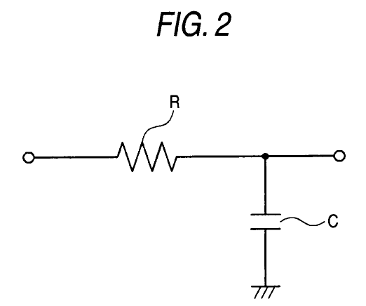

The gate on voltage generating section 40 generates a VGG voltage for controlling the gate driving circuit 20 in synchronization with the gate driving timing signal supplied from a timing controller, not shown. The gate on voltage generating section 40 includes a CR time-constant circuit having a capacitor C and a resistor R, as shown in FIG. 2. When a pulse-shaped gate driving timing signal is input to the CR time-constant circuit, a VGG voltage having a dull trailing edge is generated based on the time-constant τ (=CR) determined by the capacitor C and resistor R.

In the gate on voltage generating section 40, the time-constant τ is changed by adjusting the values of the capacitor C and resistor R of the CR time-constant circuit, and the gradient at the trailing edge of a VGG voltage can thus be adjusted. For example, the steepness of the gradient at the trailing edge is decreased by increasing the value of the time-constant τ. The steepness of the gradient at the trailing edge is increased by decreasing the value of the time-constant τ. The thus generated VGG voltage is supplied to the gate line driving circuit 20.

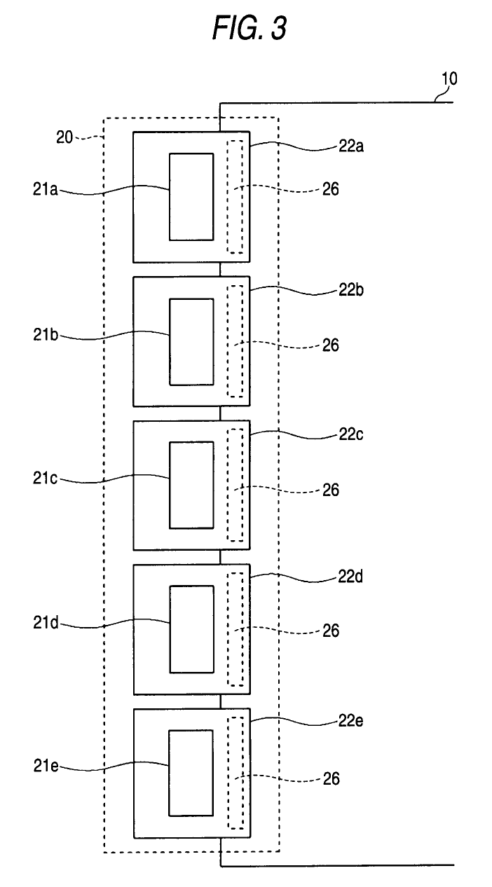

Next, an example configuration of the gate line driving circuit 20 will be described. The gate line driving circuit 20 includes, as shown in FIG. 3, multiple gate drivers 21a, 21b, 21c, 21d and 21e (which will be called gate drivers 21 properly if the distinction among the gate drivers is not necessary). It should be noted that the invention is not limited to the example where the gate line driving circuit 20 includes five gate drivers 21, which will be described, but the number of gate drivers 21 may be increased or decreased according to the number of gate lines 50 and/or the size of the display panel.

The gate drivers 21 supply the gate lines 50 the control signals for lighting up a desired pixel 12 by turning on/off the switch elements 11 based on the VGG voltages supplied from the gate on voltage generating section 40. One gate driver 21 can drive multiple gate lines 50. More specifically, one gate driver 21 can drive approximately 200 gate lines 50.

The gate drivers 21a to 21e are implemented on flexible wiring substrates 22a to 22e (which will be called flexible wiring substrates 22 properly if the distinction among the flexible wiring substrates is not necessary) by using the implementation method called TCP (Tape Carrier Package) or COF (Chip On Film) and are connected to the display panel 10.

The flexible wiring substrates 22 on which the gate drivers 21 are implemented are connected to the display panel 10 through ACFs (Anisotropic Conductive Films) 26, each of which is a film containing a mix of conductive particles in an insulating adhesive.

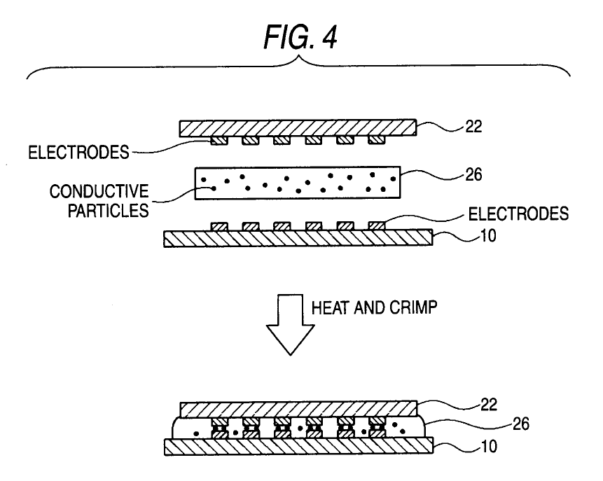

In a case where the flexible wiring substrates 22 and the display panel 10 are connected, the ACFs 26 are sandwiched between the flexible wiring substrates 22 and the display panel 10, as shown in FIG. 4. The electrodes of the flexible wiring substrates 22 and the electrode of the display panel 10, which face against each other vertically, are electrically connected through the conductive particles by heating the flexible wiring substrates 22 and the display panel 10 at a predetermined temperature for a predetermined period of time to crimp them. Furthermore, the electrodes adjacent to each other horizontally are insulated.

Next, a method for connecting the gate line driving circuit 20, gate on voltage generating section 40 and display panel 10 will be described. As described in Description of the Related Art, in a case where one VGG voltage is supplied from the gate on voltage generating section 40 to all of the gate drivers 21, the VGG voltage becomes dull as the wiring distance from the gate on voltage generating section 40 increases due to the effects by the wiring resistance and/or wiring capacitance, for example, of the wires from the gate on voltage generating section 40 to the gate drivers 21, which may therefore cause variations in intensity.

Accordingly, according to an embodiment of the invention, the gate on voltage generating section 40 generates multiple VGG voltages and supply different VGG voltages to sets of a predetermined number of gate drivers 21 such that the waveforms of the VGG voltages can be substantially equal at the input ends of the gate drivers 21.

A case where one VGG voltage is supplied to adjacent two gate drivers will be considered, for example. Since the five gate drivers 21a to 21e are provided in this example, the gate on voltage generating section 40 generates three VGG voltages of a first VGG voltage to be supplied to the gate drivers 21a and 21b, a second VGG voltage to be supplied to the gate drivers 21c and 21d and a third VGG voltage to be supplied to the gate driver 21e.

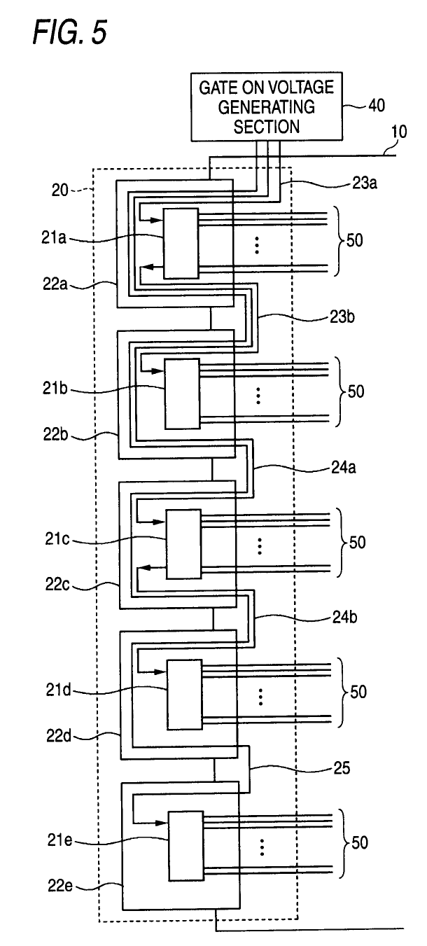

As shown in FIG. 5, the VGG voltages are supplied from the gate on voltage generating section 40 to the gate drivers 21 through the in-panel wires on the flexible wiring substrate 22 on which the gate drivers 21 are implemented and the display panel 10.

A wire 23a, a wire 24a and a wire 25 are connected to the gate on voltage generating section 40. The wire 23a is used for supplying a first VGG voltage to the gate drivers 21a and 21b. The wire 24a is used for supplying a second VGG voltage to the gate drivers 21c and 21d. The wire 25 is used for supplying a third VGG voltage to the gate driver 21e. Then, the wires 23a, 24a and 25 are connected to the gate drivers 21 through the display panel 10 and the flexible wiring substrates 22.

The wire 23a is connected to the gate driver 21a through the display panel 10 and the flexible wiring substrate 22a. The first VGG voltage output from the gate on voltage generating section 40 is supplied to the gate driver 21a through the wire 23a.

The wire 23b is connected to the gate driver 21a and the gate driver 21b through the flexible wiring substrate 22a, the display panel 10 and the flexible wiring substrate 22b. The first VGG voltage input to the gate driver 21a is output from the gate driver 21a as it is and is supplied to the gate driver 21b through the wire 23b.

The wire 24a is connected to the gate driver 21c through the display panel 10, the flexible wiring substrate 22a, the display panel 10, the flexible wiring substrate 22b, the display panel 10, and the flexible wiring substrate 22c. The second VGG voltage output from the gate on voltage generating section 40 is supplied to the gate driver 21c through the wire 24a.

The wire 24b is connected to the gate driver 21c and the gate driver 21d through the flexible wiring substrate 22c, the display panel 10 and the flexible wiring substrate 22d. The second VGG voltage input to the gate driver 21c is output from the gate driver 21c as it is and is supplied to the gate driver 21d through the wire 24b.

The wire 25 is connected to the gate driver 21e through the display panel 10, the flexible wiring substrate 22a, the display panel 10, the flexible wiring substrate 22b, the display panel 10, the flexible wiring substrate 22c, the display panel 10, the flexible wiring substrate 22d, the display panel 10 and the flexible wiring substrate 22e. The third VGG voltage output from the gate on voltage generating section 40 is supplied to the gate driver 21e through the wire 25.

In this way, the wiring distance increases as the distances from the gate on voltage generating section 40 to the gate drivers 21 increase. Therefore, the first VGG voltage, second VGG voltage and third VGG voltage output from the gate on voltage generating section 40 become dull due to the wiring resistance and/or wiring capacitance, for example, of the wiring paths when input to the gate drivers 21.

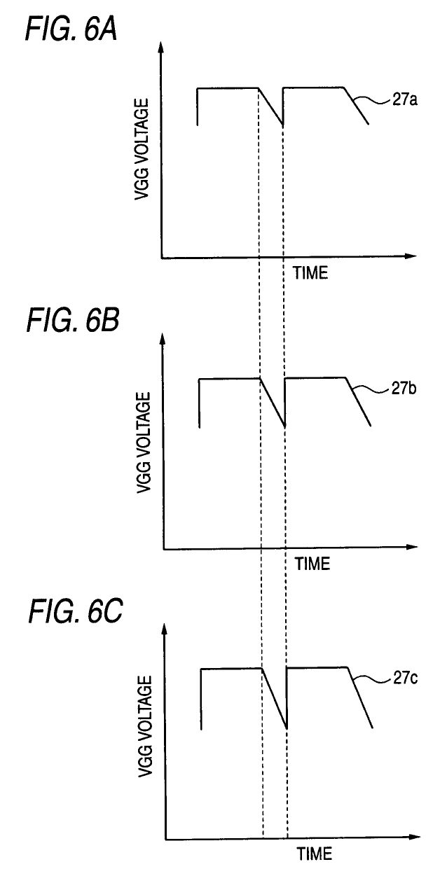

For that reason, according to an embodiment of the invention, in consideration of the dull voltage rises due to the wiring resistance and/or wiring capacitance, for example, of the wiring paths, the waveforms of the first VGG voltage 27a, second VGG voltage 27b and third VGG voltage 27c output from the gate on voltage generating section 40 are defined to differentiate the gradients at the trailing edges, as shown in FIGS. 6A to 6C.

As shown in FIG. 6A, the first VGG voltage 27a to be supplied to the gate drivers 21a and 21b is defined to have the gentlest gradient at the trailing edge. This is because the wiring distance from the gate on voltage generating section 40 to the gate driver 21a is the shortest, which causes the lowest effect by the wiring resistance and/or wiring capacitance, for example.

As shown in FIG. 6B, the second VGG voltage 27b to be supplied to the gate drivers 21c and 21d is defined to have a steeper gradient at the trailing edge than that of the first VGG voltage 27a. This is because the wiring distance from the gate on voltage generating section 40 to the gate driver 21a is longer than the wiring resistance to the gate driver 21a, which causes a higher effect by the wiring resistance and/or wiring capacitance, for example.

As shown in FIG. 6C, the third VGG voltage 27c to be supplied to the gate driver 21e is defined to have the steepest gradient at the trailing edge, compared with the first VGG voltage 27a and second VGG voltage 27b. This is because the wiring distance from the gate on voltage generating section 40 to the gate driver 21e is longer than the wiring distance to the gate driver 21a, which causes the highest effect by the wiring resistance and/or wiring capacitance, for example.

In this way, the waveforms of the VGG voltages at the input ends of the gate drivers can be substantially equal by differentiating the waveforms of the VGG voltages output from the gate on voltage generating section 40 according to the wiring distances from the gate on voltage generating section 40 to the gate drivers. Therefore, the waveforms of the control signals output from all of the gate drivers 21 to the gate lines 50 become substantially equal, which can reduce variations in intensity due to the differences in waveforms.

Having described the embodiments of the invention, the invention is not limited to the embodiments of the invention, but various changes and applications can be made without departing from the scope and spirit of the invention. For example, having described the example in which the gradients at the trailing edges of the first, second and third VGG voltages 27a, 27b and 27c are differentiated, the invention is not limited to the example. For example, in a case where the voltage levels of the VGG voltages at the input ends of the gate drivers depend on the wiring distances, the first, second and third VGG voltages may be generated in consideration of the amounts of changes of the voltage levels in addition to the gradients at the trailing edges.

Furthermore, the VGG voltage to be generated by the gate on voltage generating section 40 may be increased or decreased according to the number of the gate drivers 21 in the gate driving circuit 20, for example.

Having described the example in which one VGG voltage is supplied to two gate drivers 21, the invention is not limited to the example. Different VGG voltages may be supplied to one gate driver 21 in order to increase the precision of the waveforms of the VGG voltages to be supplied to the gate drivers 21, for example. Alternatively, one VGG voltage may be supplied to three or more gate drivers 21.

Having described the example where TCP or COF is used as the technology for implementing gate drivers on flexible wiring substrates in this example, the invention is not limited to the example. For example, the invention is also applicable to cases using COG (Chip On Glass), which is a technology for implementing an IC (integrated circuit) such as the gate driver 21 on a glass substrate or SOG (System On Glass), which is a technology for implementing the entire circuit such as the gate line driving circuit 20 on a glass substrate.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus in which switch elements and pixels are placed at intersections between multiple gate lines and multiple data lines on a display panel that displays video and which displays video by controlling the lighting of the pixels by turning on/off the switch elements based on the voltages applied to the gate lines and the data lines, the apparatus comprising:
a gate on voltage generating section that generates multiple VGG voltages (gate on power supply voltages) for controlling the switch elements and controls the gradients at least at the trailing edges of the VGG voltages;
gate drivers that generate control signals that control the lighting of the pixels by turning on/off the switch elements based on the VGG voltages and supply the control signals to the gate lines; and
wires that supply the VGG voltages separately to one or multiple sets of the gate drivers,
wherein the gate on voltage generating section supplies multiple VGG voltages having different gradients at least at the trailing edges to the one or multiple sets of gate drivers through the wires.

2. The display apparatus according to claim 1,
wherein the gate on voltage generating section controls the gradients at least at the trailing edges of the VGG voltages based on the distances of the wires.

3. The display apparatus according to claim 2, wherein the gate on voltage generating section controls such that the steepness of the gradients of the VGG voltages at the trailing edges increases as the distances of the wires increase.

4. The display apparatus according to claim 1, wherein the wires are provided on the display panel.
